(19) United States
(12) Patent Application Publication
(10) Pub. No.: US 2015/0331836 A9
(43) Pub. Date: Nov. 19, 2015

(54) GRACEFUL DEGRADATION OF LEVEL-OF-DETAIL IN DOCUMENT RENDERING

(71) Applicant: OPERA SOFTWARE ASA, Oslo (NO)

(72) Inventor: Marcus GEELNARD, Goteborg (NO)

(73) Assignee: OPERA SOFTWARE ASA, Oslo (NO)

(21) Appl. No.: 13/652,843

(22) Filed: Oct. 16, 2012

Related U.S. Application Data
(60) Provisional application No. 61/547,955, filed on Oct. 17, 2011.

(51) Int. Cl. G06F 17/21; G06T 1/60

(52) U.S. Cl. CPC G06F 17/212; G06T 1/60; G06T 2200/28

(57) ABSTRACT

In the present invention, a combination of asynchronous rendering and synchronous rendering is utilized to render an electronic document on the screen of a computing device. Particularly, a document-rendering application may be configured to draw asynchronously a high-detail version of the document to a rendering cache. This high-detail version is used to paint the document to the screen in a synchronous screen refresh operation. If, during the screen refresh operation, there are parts of the viewport that the asynchronous process has not finished rendering, these missing parts are filled in with a low-detailed version of the document that is painted fast enough to maintain the high screen refresh rate. For example, the low-detailed version of the document may show the basic structure of the document including the background color, layout boxes, and lines. However, other elements of the document may be replaced or excluded entirely from the less-detailed version.

### FIELD OF THE INVENTION

The invention relates to the rendering of an electronic document such as webpages, and particularly to the rendering of such document during a screen refresh operation.

### BACKGROUND OF THE INVENTION

Painting an electronic document to a screen, e.g., in a web browser, is usually a relatively complex and slow process that is difficult to achieve with a constant, high screen refresh rate, especially for mobile devices (e.g., smartphones, tablet computers, etc.). As such, there is a natural tradeoff between high screen refresh rates (which yield a smooth user experience) and how much of the document can be drawn during each screen refresh.

For instance, when performing a panning or a zoom (in or out) operation, the goal is to get the smoothest possible experience between screen refreshes. Thus, a tradeoff has been made in existing solutions in that the complete viewport is not drawn during each screen refresh, thereby maintaining a high refresh rate.

In mobile devices, a solution utilizing “asynchronous rendering” has been offered to help speed-up the rendering process. In such solutions, a mobile browser executes a thread to render parts (tiles) of the document that are likely to be in the mobile device's viewport in the next few frames. These rendered tiles are sent to buffers in the mobile browser (sometimes referred to as “rendering cache”). Thus, during screen refreshes, the browser attempts to retrieve the already-rendered tiles from the buffers and apply them to the screen. However, according to this solution, if the thread has not yet finished painting the relevant tiles for the screen refresh (e.g., during a panning or zoom operation), the browser may draw a preset “filler” background image such as a checkerboard pattern. This may provide an unsettling viewing experience for the user.

### SUMMARY OF THE INVENTION

According to an exemplary embodiment of the present invention, a combination of asynchronous rendering and synchronous rendering is utilized to render an electronic document on the screen of a computing device (e.g., mobile device). According to this exemplary embodiment, a document-rendering application (e.g., web browser, PDF viewer, word processor, etc.) may be configured to draw asynchronously a high-detail version of the document (including images, text, boxes, etc.) to a rendering cache. This high-detail version is used to paint the document to the screen in a synchronous screen refresh operation. If, during the screen refresh operation, there are parts of the viewport that the asynchronous process has not finished rendering, these missing parts are filled in with a low-detailed version of the document that is painted fast enough to maintain the high screen refresh rate. The low-detailed version of the document may show the basic structure of the document including the background color, layout boxes, and lines. However, other elements of the document may be replaced or excluded entirely from the less-detailed version. For instance, images in the document may be replaced by colored boxes, and text may be excluded entirely.

Furthermore, the principles of the present invention can be used to render a variety of document types, including but not limited to markup language documents (e.g., webpages), word processing files, PDF (Portable Document Format) files, SVG (Scalable Vector Graphics) files, etc.

### BRIEF DESCRIPTION OF THE DRAWINGS

FIG. 1 illustrates the basic architecture of a computing device that can operate as either a client device or a server according to exemplary embodiments of the present invention;

FIG. 2 illustrates the basic architecture of a web browser implemented on a client device according to an exemplary embodiment of the present invention;

FIG. 3 illustrates a block diagram of a rendering engine, which may be implemented in a web browser or other document-rendering application, according to an exemplary embodiment of the present invention; and

FIGS. 4 and 5 are flowcharts illustrating example implementations of processes corresponding to asynchronous rendering and screen refresh, respectively, according to exemplary embodiments of the present invention.

### DETAILED DESCRIPTION

The present invention seeks to improve the document viewing experience for a user of electronic devices, such as mobile devices (e.g., smartphone, tablets, etc.) with limited processing capabilities. Particularly, the present invention provides a smoother viewing experience, e.g., during a document panning or zooming operation, by combining synchronous rendering and asynchronous rendering operations.

For purposes of this detailed description, “synchronous rendering” will be used to refer to document rendering operations that are carried out by a particular thread of execution during a screen refresh cycle, e.g., in addition to rendering other user interface (UI) elements. In synchronous rendering, the operations are carried out within each refresh cycle by this thread regardless of whether a scroll or zoom operation is being carried out. “Asynchronous rendering,” on the other hand, will be used to refer to paint operations carried out in a separate thread, which are not synchronized to the screen refresh cycles. The operations performed by the asynchronous thread will not block the screen refresh thread, regardless of how long these operations take. One of the reasons for having asynchronous rendering is to make the user interface responsive, even if the document takes a long time to paint.

Further, the present invention may be capable of utilizing a “graceful degradation” of the level of detail of the rendered document, by configuring a screen refresh thread to supplement a higher-detailed asynchronous rendering, which is performed by another thread, with a lower-detailed synchronous rendering. Thus, if the higher-detailed asynchronous rendering cannot be completed for a particular screen refresh, the less-detailed synchronous rendering can be used to fill in the missing parts.

The principles of the present invention may be implemented in a mobile environment in which users are able to browse the Internet using their mobile devices (phone, tablet computer, etc.), e.g., via a 3G or 4G-compliant network or a wireless network based on Wi-Fi (IEEE 802.11), WiMAX (IEEE 802.16) or any other available standard for wireless communication. However, the present invention is not limited to a mobile implementation, and the principles described herein may also be applied to a desktop browsing environment. Furthermore, the present invention is not limited to web browsing software applications. For instance, the principles of the present invention could be applied to different types of software applications that rely on some sort of document rendering including but not limited to word processors, PDF viewers, and SVG viewers

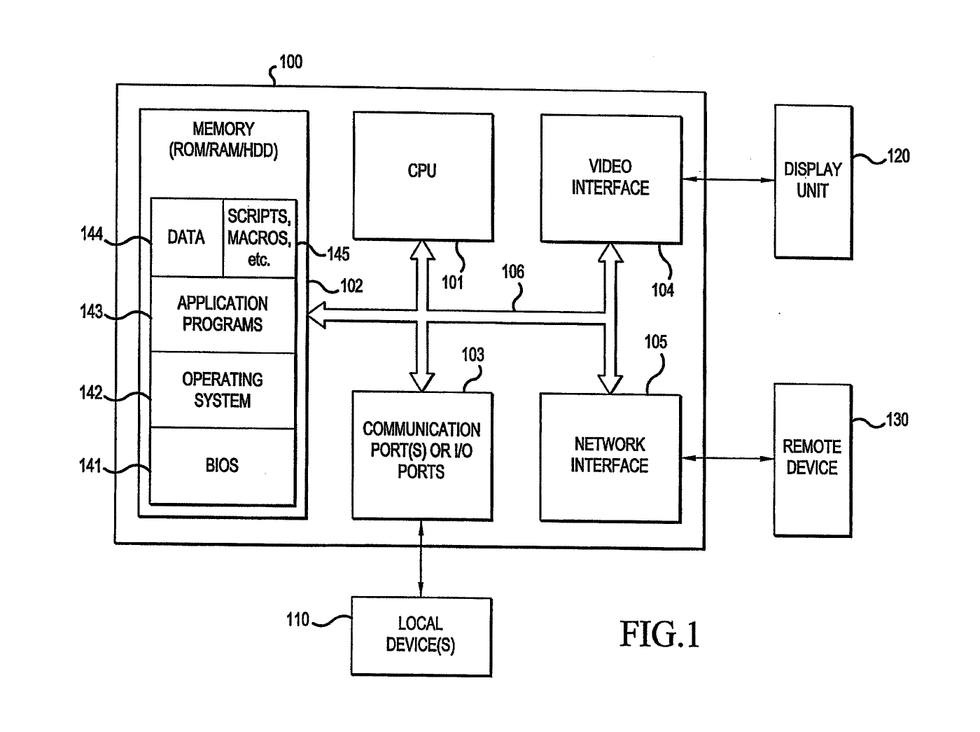

FIG. 1 illustrates a generalized computing device 100 that can be used as an environment for implementing various aspects of the present invention. For instance, the computing device 100 may be implemented as a client device, i.e., a user's computing device on which a web browser is installed to request webpages or resources from the server. Examples of such client devices include a mobile device (e.g., a cellphone, a smartphone, a tablet computer, etc.) or a general purpose desktop computer such as a PC. However, the computing device 100 of FIG. 1 may also be implemented as a server-side device, e.g., as a web server, a proxy server. However, it is not entirely necessary for the computing device 100 to be implemented in a client/server environment in order to implement various principles of the present invention as described in more detail below.

In FIG. 1, a computing device 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memories, stores the various software components of the system. The software components in the memory 102 may include a basic input/output system (BIOS) 141, an operating system 142, various computer programs 143 including applications and device drivers, various types of data 144, and other executable files or instructions such as macros and scripts 145. For instance, the computer programs 143 stored within the memory 102 may include any number of applications, including a web browser and other web applications that may be executed in accordance with principles of the present invention.

In FIG. 1, the communication ports 103 may be connected to one or more local devices 110 such as user input devices, a printer, a media player, external memory devices, and special purpose devices such as, e.g., a global positioning system receiver (GPS). Communication ports 103, which may also be referred to as input/output ports (I/O), may be any combination of such ports as USB, PS/2, RS-232, infra red (IR), Bluetooth, printer ports, or any other standardized or dedicated communication interface for local devices 110.

The video interface device 104 is connected to a display unit 120 which may be an external monitor or an integrated display such as an LCD display. The display unit 120 may have a touch sensitive screen and in that case the display unit 120 doubles as a user input device. The user input device aspects of the display unit 120 may be considered as one of the local devices 110 communicating over a communication port 103.

The network interface device 105 provides the computing device 100 with the ability to connect to a network in order to communicate with a remote device 130. Such network, which in FIG. 1 is only illustrated as the line connecting the network interface 105 with the remote device 130, may be, e.g., a local area network or the Internet. The remote device 130 may in principle be any computing device (e.g., client or server) with similar communications capabilities as the device 100.

It will be understood that the computing device 100 illustrated in FIG. 1 is not limited to any particular configuration or embodiment regarding its size, resources, or physical implementation of components. For example, more than one of the functional components illustrated in FIG. 1 may be combined into a single integrated unit of the computing device 100. Also, a single functional component of FIG. 1 may be distributed over several physical units. Other units or capabilities may of course also be present.

In an exemplary embodiment, various aspects of the present invention may be incorporated into, or used in connection with, the components and/or functionality making up a web browser installed as an application on a single computing device 100, or configured as a distributed application running on two or more computing devices 100.

While the terms “web browser” and “browser” are used throughout this specification, it should be understood that such terms are not intended to limit the present application only to traditional web browser programs, but instead cover any type of user agent or web application that is capable of sending URL requests for data resources (including, but not limited to, web pages) over the World Wide Web consistent with the principles of the present invention. Certain embodiments of the invention may also involve applications that access content that has already been made available locally without communicating with other networked devices.

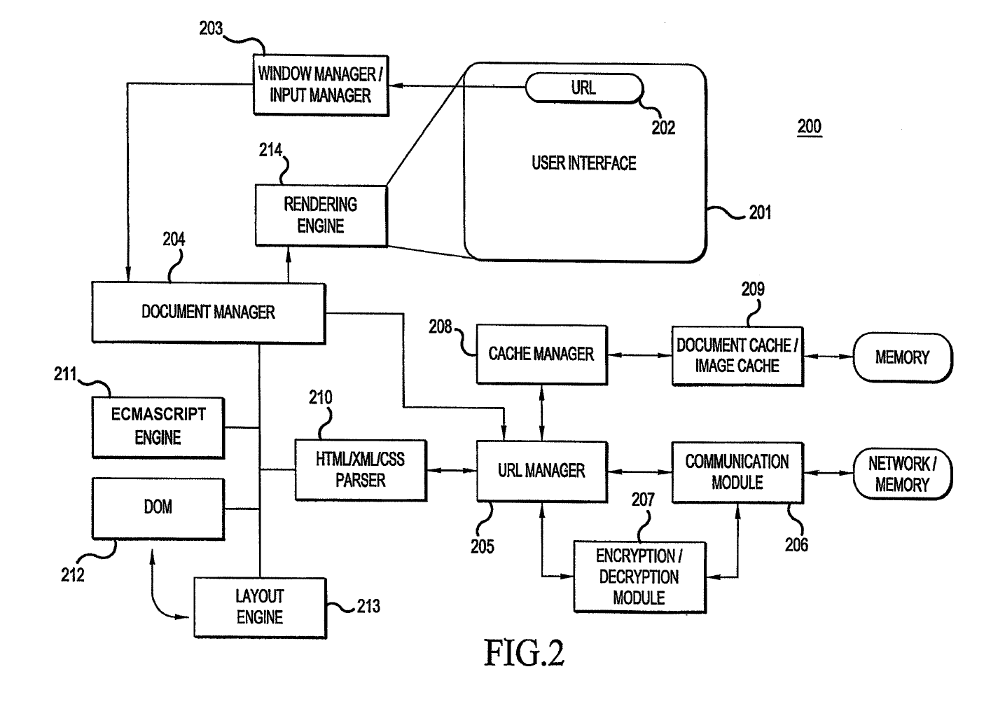

FIG. 2 illustrates the basic architecture of a web browser 200 that can be used in connection with the present invention. Particularly, FIG. 2 shows an example of various modules that may be present in such a web browser 200. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The web browser 200 presents the user with a user interface 201 that may be displayed on the display unit 120 shown in FIG. 1. The web browser 200 illustrated in FIG. 2 may be configured either an application running on a single computing device 100, or alternatively as a distributed application running over a client device (e.g., mobile terminal) and a server (commonly referred to as a “proxy server”). If implemented as a distributed application (i.e., distributed browser), each of the modules illustrated in FIG. 2 may reside on the client device, the server, or both. In a particular example of a distributed browser implementation, modules 210, 211, 212, and 213 of FIG. 2 may reside solely in the proxy server; modules 201, 202, and 203 may reside solely in the client device; and the remaining modules may reside on both the client and the server (although such modules may be programmed to perform slightly different operations on the two devices).

In FIG. 2, the user interface 201 may include an address field 202 in which the user may input or select the URL of a document or a service he or she wants the browser 200 to retrieve. For example, the user may use an input device (e.g., keyboard) to type in the URL in the address field 202. The address field 202 may also be a link that is displayed and may be activated by the user using a pointing device such as a mouse. Alternatively the URL may be specified in the code of a document or script already loaded by the web browser 200.

In any case, the URL may be received by a window and input manager 203 that represents the input part of the user interface 201 associated with, or part of, the browser 200. The URL may then be forwarded to a document manager 204, which manages the data received as part of the document identified by the URL.

The document manager 204 forwards the URL to a URL manager 205, which instructs a communication module 206 to generate a web page request, i.e., a request for access to the identified resource. The communication module 206 may be capable of accessing and retrieving data from a remote device 130 such as a server over a network using the hypertext transfer protocol (HTTP), or some other protocol such as HTTP Secure (HTTPS) or file transfer protocol (FTP). The communication module 206 may also be capable of accessing data that is stored in the local memory 102 of the computing device 100.

Referring again to FIG. 2, the web browser 200 may include an encryption/decryption module 207 to handle communication between the URL manager 205 and the communication module 206, if communication outside the computing device 100 is required to be encrypted (e.g., as specified by the protocol used for accessing the URL).

The data received by the communication unit 206 in response to a webpage request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL manager 205 forwards the data received from the communication port 206 or cache 209 to a parser 210 capable of parsing content such as HTML, XML and CSS. The parsed content may then, depending on the type and nature of the content, be processed further by an ECMAScript engine 211, a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

When the data representing the content of the specified document has been processed it is forwarded from the document manager 204 in order to be rendered by a rendering engine 214 and displayed on the user interface 201.

The various modules thus described are executed by the CPU('s) 101 of computing device(s) 100 as the CPU('s) 101 receive(s) instructions and data over the system bus(es) 106. The communications module 206 communicates with the remote device 130 using the network interface 105. The functionality of various modules in FIG. 2 may of course be integrated into fewer larger modules. Also, the functionality of a single module in FIG. 2 may be distributed or replicated over several modules.

It will further be understood that, while the various modules of the web browser 200 described above may be implemented as part of an application program 143 running on one or more computing devices 100, some of the browser's 200 functionality may also be implemented as part of the operating system 142 or even the BIOS 141 of the corresponding device 100. Further, the content received in response to a webpage request may include data 144, script 145, or a combination thereof.

A webpage is a document typically written in HTML, XHTML or other similar markup languages. Often, HTML pages are styled with CSS style sheets which combine textual content with images (e.g., in JPEG, GIF or PNG formats), video (e.g., in the WebM format) or plugins (e.g., in the SWF format) in order to form comprehensive visual presentations. These presentations, which are typically generated by the rendering engine 214 of a web browser 200, as described above in connection with FIG. 2, often require more space than the current viewport of the user interface 201 can offer at a reasonable resolution. Other types of documents (e.g., word processing or PDF files) may similarly include content of one or more types (text, images, etc.) which collectively requires more space than is available in the viewport at a given time. Typically, web browsers and other document-rendering applications have solved this problem by offering scrollbars or other panning tools that may be manipulated by the user to move a different portion of the document to the viewport. Also, browsers and other document-rendering programs usually provide a zoom-in or zoom-out tool which allows the user to change the amount (and detail of) information viewable in the viewport.

Many times, execution of a panning or zoom operation as described above will span multiple screen refresh cycles. During each of these refresh cycles, an incrementally-panned or incrementally-zoomed version of the document may be painted on screen thus giving a visual effect to the user of a continuous panning a zoom operation. Further, exemplary embodiments of the present invention may provide a smoother viewing during such panning or zoom operation by using both synchronous rendering and asynchronous rendering during each screen refresh.

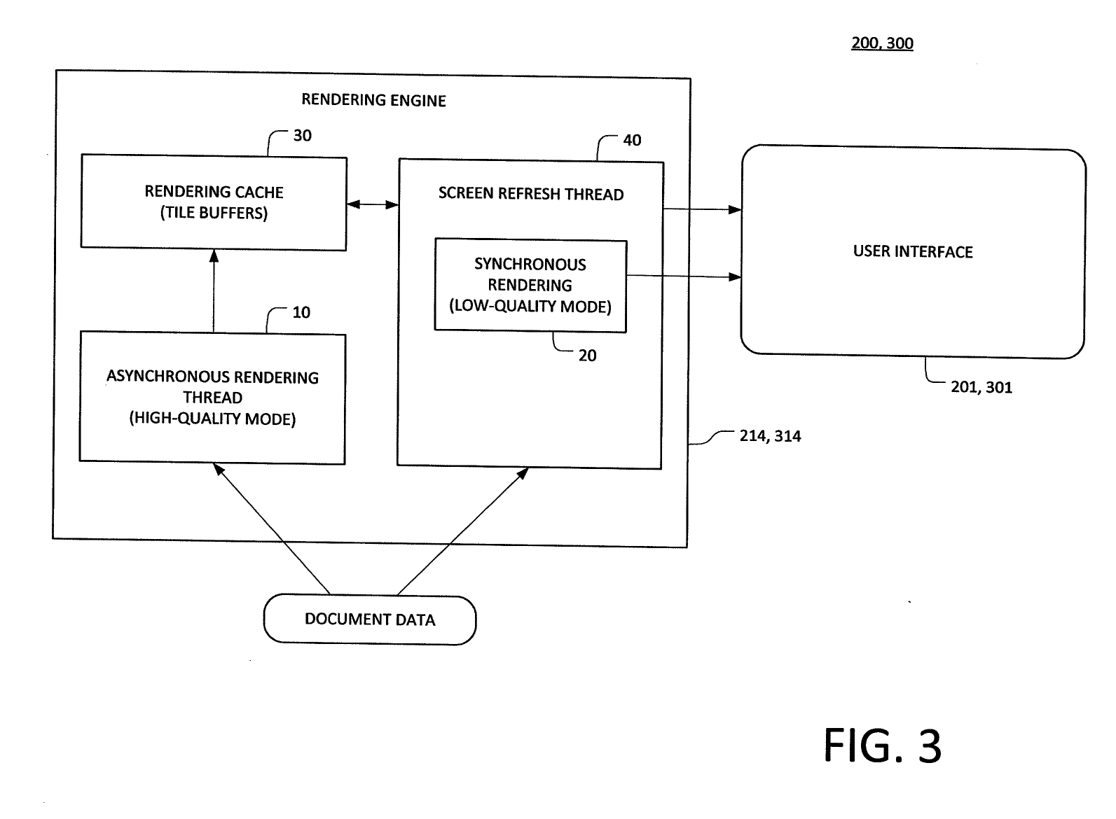

FIG. 3 illustrates a block diagram of a rendering engine, which may be implemented in a web browser 200 or another document-rendering application 300, according to an exemplary embodiment of the present invention.

For instance, if implemented as part of the example embodiment described above in which principles of the present invention are implemented in a web browser 200, the rendering engine of FIG. 3 may be implemented as the browser's rendering engine 214 described above in connection with FIG. 2. As such, this rendering engine 214 may be configured to render a document as part of the user interface 201 of the browser 200 illustrated in FIG. 2. However, an alternative embodiment of the present invention may utilize a different type of document-rendering application 300 (e.g., word processor, PDF viewer, SVG viewer, etc.), which still utilizes a rendering engine of the same fundamental design as the browser's 200. Thus, FIG. 3 illustrates alternative reference numeral 314 for the rendering engine, to reflect the alternative embodiment involving the different type of application 300 (and user interface 301).

Referring to FIG. 3, the document data is received in the rendering engine 214, 314, and sent to dual threads 10 and 40. Particularly, the document data is sent to a high-quality rendering thread 10 which may apply an asynchronous rendering process on the data. The document data is also sent to a screen refresh thread 40, which is capable of invoking a synchronous rendering function 20 to apply a synchronous rendering process on the data.

An explanation of the term “thread” will now be provided. This explanation is merely offered for clarification purposes—it is not intended to provide an exhaustive definition of the term, nor is it intended to modify the definition of the term as understood by those skilled in the art. A thread (sometimes referred to as “thread of execution”) is the smallest unit of processing that can be scheduled by an operating system. A thread generally exists as a subset of a process, and it is possible for multiple threads to exist in the same process (and thus share process state, memory, and resources). Such “multithreading” makes it possible to perform parallel execution of a process across multiple central processing units (CPU's) either on the same machine or on multiple machines. However, multithreading can also be employed on a single CPU, e.g., using time-division multiplexing. Also, multithreading makes it possible for an application to be responsive to user input via the main execution thread, while other tasks are being performed by one or more threads that are concurrently run.

Referring again to FIG. 3, the rendering engine 214, 314 may comprise a multithreaded process utilizing the asynchronous rendering thread 10 and the screen refresh thread 40 to draw the document. According to one exemplary embodiment of the present invention, the process of the rendering engine 214, 314 may be performed by a single CPU 101 programmed to perform multithreading (e.g., according to time-division multiplexing). It is also possible to utilize a single CPU 101 with multiple cores for parallel execution of the threads 10 and 40. As another alternative, the computing device 100 rendering the document may include two CPU's 101 which execute the asynchronous rendering thread 10 and screen refresh thread 40 in parallel. It might even be possible to distribute the rendering process across two computing devices 100, e.g., a mobile device and a server (or other machine with higher processing capability).

According to an exemplary embodiment, the synchronous rendering function 20 is invoked or called by the screen refresh thread 40 when needed. For instance, during a particular refresh cycle, if certain parts of the document in the viewport are not yet finished by the asynchronous rendering thread 10, the synchronous rendering function 20 can be invoked by the thread 40 to paint those parts onto the screen. In an alternative embodiment, however, the synchronous rendering function 20 may be invoked every screen cycle, e.g., to render certain elements of the document which the asynchronous rendering thread 10 is programmed not to draw.

Regardless of which embodiment is implemented, however, the synchronous rendering function 20 should employ an algorithm that can be carried out and completed within each screen refresh cycle. Particularly, function 20 should utilize a rendering algorithm that renders a sufficiently low level of detail of the document to ensure that the viewport will be drawn fast enough to maintain the desired refresh rate of the rendering engine 214, 314. As shown in FIG. 3, the results of the synchronous rendering function 20, when invoked by the screen refresh thread, may be painted to the viewport of the user interface (UI) 201, 301.

The asynchronous rendering thread 10 in FIG. 3 utilizes a drawing algorithm that provides a higher level of detail of the document than the synchronous rendering function 20. For instance, the asynchronous rendering algorithm may try to anticipate the portions of the document most likely to be viewable in the UI viewport within the next few screen refreshes. The algorithm then starts rendering these portions of the document in a high-quality mode, i.e., with a high level of detail) to respective buffers in the rendering cache 30.

As used in this specification, “level of detail” refers to a concept by which the complexity of drawing a document representation may be decreased by omitting certain details from the representation as higher rendering speeds are required. The reduced visual quality of the rendered document reduces the workload on the rendering algorithm thus increasing efficiency. A similar concept has been applied to three-dimensional (3D) graphical objects, in which the detail level in which contour edges, shading, texture, etc., is varied according to the object's distance from the viewer, importance, position, etc. However, in the context of document rendering, the level of detail may determine which (if any) of the contents of the document (text, images, etc.) are drawn. For example, if the level of detail for a document is designated as “full level,” all of the document's content may be rendered. The level of detail may be lowered for a document, on the other hand, by omitting certain types of content or elements including images and/or text. Another possible way to decrease the level of detail of a document would be to use a simpler representation of certain document elements, e.g., by replacing images with colored boxes of similar size and shape.

According to embodiments of the present invention, two different levels of detail are used: “high detail” and “low detail.” Particularly, the asynchronous rendering thread 10 may be programmed to render at the high-detail level (i.e., high-quality mode), while the synchronous rendering function 20 may be programmed to render at the low-detail level (i.e., low-quality mode).

For instance, the high level of detail implemented by the asynchronous rendering thread 10 may correspond to a fully-detailed drawing of the document including all contents. However, it is also possible for the asynchronous rendering algorithm in thread 10 to omit certain elements from its rendering. For example, the asynchronous rendering thread 10 may be programmed not to draw those elements which will be drawn by the synchronous rendering function 20.

The synchronous rendering function 20 may be programmed to render the document at low detail by drawing only the basic structure of the document (background color, layout boxes and lines, etc.), replacing images with colored boxes, and omitting text entirely. However, this is but one example of how the low-detail rendering may be accomplished, and alternative methods may be employed by the synchronous rendering function 20. Preferably, the low-detail rendering by function 20 should avoid drawing document elements that are known to be slow to draw. As to exactly what would be considered “slow” or “fast” to draw may depend on the type of document being rendered (e.g., for SVG images, blurred shapes may be considered slower to render than regular shapes). Also, the underlying rendering infrastructure (e.g., device hardware, graphics API's, etc.) may be determinative of what types of elements are fast or slow to render. However, the synchronous rendering function 20 may employ any algorithm that avoids drawing enough document elements to ensure the drawing will be completed within each screen refresh cycle.

Referring again to FIG. 3, the asynchronous rendering thread 10 draws the document in high detail to a rendering cache 30. The contents of the rendering cache 30 are available to be drawn by the screen refresh thread 40 onto the UI viewport for a screen refresh. For any portions of the viewport unfinished by the asynchronous rendering thread 10 (and thus not available in the rendering cache 30), the screen refresh thread 40 is able to call the synchronous rendering function 20 to paint such portions to the UI viewport.

As described above, the screen refresh thread 40 paints the document onto the screen during each screen refresh cycle, on the basis of what has been rendered by the asynchronous rendering thread 10 and (if needed) the synchronous rendering function 20. Particularly, the screen refresh thread 40 paints those parts of the document that will fit within the viewport during the current refresh (referred to herein as “viewport document”).

It is worth mentioning now that the asynchronous rendering thread 10 and the screen refresh thread 40 may need to demarcate the viewport document from the document data. To do this, the threads 10 and 40 may need to be notified, e.g., by the user interface module 201, 301, as to the state of any panning or zoom operation currently being performed on the document.

In a given refresh cycle, the screen refresh thread 40 accesses the rendering cache 30 in order to paint those parts of the viewport document that have been rendered by the asynchronous rendering thread 10. As to those parts of the viewport document that have not been rendered in time by the asynchronous rendering thread 10 (and are thus missing from the rendering cache 30), the screen refresh thread 40 uses the low-detail version of those parts as painted by the synchronous rendering function 20.

According to an exemplary embodiment, the document to be rendered is divided into a particular number of partitions or “tiles.” The dividing operation may be performed by each of the asynchronous rendering thread 10 and the screen refresh thread 40. Alternatively, the dividing operation may be performed by another thread, and the tiling may be reflected in the document data received by the threads 10 and 40. When dividing the document into tiles, such operation may take into account the current zoom or scale factor of the document so that (at least roughly) the same number of tiles will be viewable on the screen at any given moment. A possible exception to this “same number of tiles” rule may occur when a zoom operation is performed, and tiles are being scaled (up or down) before new tiles have been rendered according to the new zoom level.

Furthermore, the rendering cache 30 may be comprised of separate buffers into which respective tiles of the document are to be drawn by the asynchronous rendering thread 10. The number of “tile buffers” in the rendering cache 30 may be higher than the number of document tiles that are actually viewable in the viewport, to help accommodate for panning operations. Further, during each screen refresh, the screen refresh thread 40 may be programmed to determine which document tiles are currently viewable in the viewport, and also find out which tile buffers of the rendering cache 30 are assigned to these “viewport document tiles.” Thus, during each refresh, the screen refresh thread 40 can check which of the tile buffers corresponding to the viewport document tiles have been written to by the asynchronous rendering thread 10, paint those buffers to the screen, and paint any unfinished viewport document tiles using the synchronous rendering function 20.

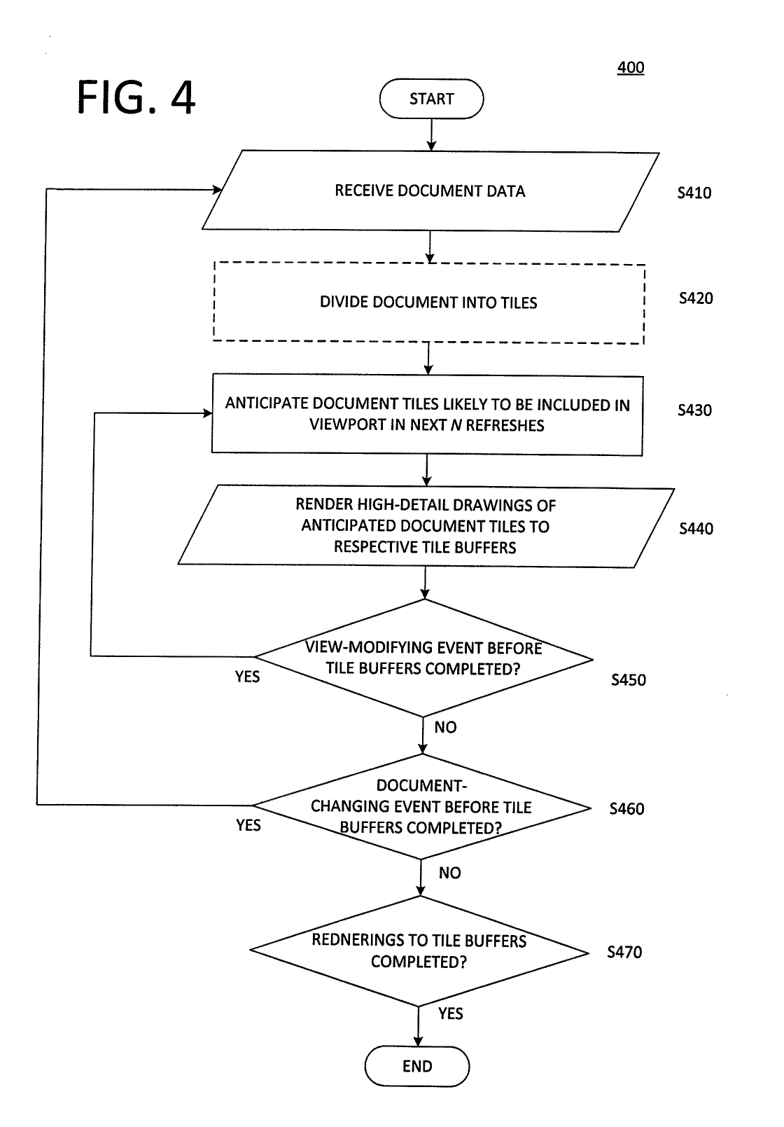

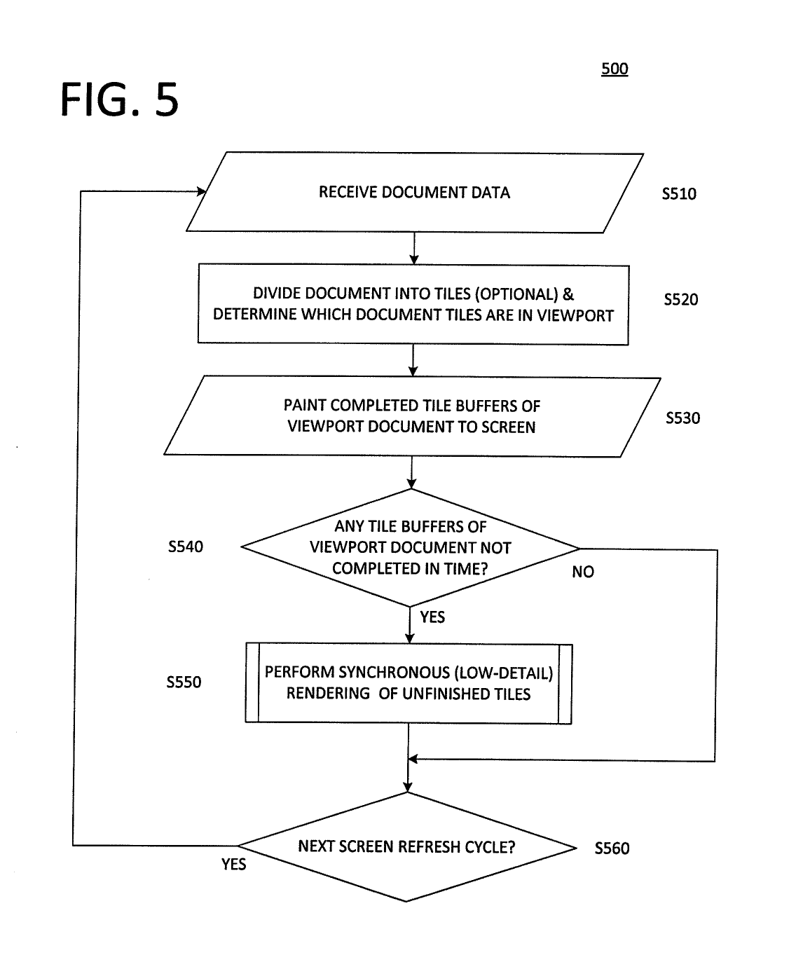

FIGS. 4 and 5 further illustrate this embodiment of the present invention. FIG. 4 is a flowchart illustrating an example embodiment of a process 400 for asynchronous rendering employed in thread 10. FIG. 5 is a flowchart illustrating an example embodiment of a process 500 that can be employed in the screen refresh thread 40. It should be noted that these figures are provided for illustration only, and are not intended to be limiting. For example, the sequence of operations illustrated in these figures may be changed, and some of the operations may be omitted. Also, other operations may be added to the underlying algorithms as necessary.

First, the process 400 of FIG. 4 will be described. In operation S410, the asynchronous rendering thread 10 receives the document data, as shown in FIG. 3. Further, the document may be divided into tiles or partitions according to operation S420. However, the performance of S420 may not necessarily be performed in the asynchronous rendering thread 10. E.g., the document may be divided into tiles elsewhere, and the document data received in S410 may include an indication of tile boundaries. In view of this, S420 is illustrated with dotted lines to indicate that it is an optional operation in FIG. 4.

As the name implies, the asynchronous rendering thread 10 operates asynchronously with respect to the screen refreshes. In other words, the asynchronous rendering process 400 is not synchronized to the operation of the screen refresh thread 40 or synchronous rendering function 20, but instead works independently thereof. As such, the process 400 may be designed so that each iteration thereof spans multiple screen refresh cycles. Accordingly, operation S430 anticipates which portions (tiles) of the document will most likely be in the viewport in the next N refreshes (N being an integer greater than or equal to 1). For example, if the user is currently scrolling or panning the document, S430 may be able to determine which document tiles will move into the viewport document during each of the next N refreshes based on calculations involving the rate and direction of scrolling/panning. Similarly, if the user is performing a zoom operation, parameters such as the position and scale of the zoom may be used in S430 to anticipate which document tiles will be contained in the viewport (and possibly rescaled) in the next N screen refreshes.

According to operation S440, the document tiles anticipated to appear in the viewport (as determined in S430) are rendered in high detail to corresponding tile buffers of the rendering cache 30. As illustrated in FIG. 4, this rendering operation S440 may continue until completed (see S470), unless the process is interrupted (see, e.g., S450 and S460).

For example, as illustrated in S450, the asynchronous rendering thread 10 may be notified of an event changing how the document is to be viewed. Such events may occur, e.g., when the user inputs a command to perform a zoom operation, jump to another portion of the document (e.g., “page down” or “page up” commands), etc. Although such events may not change the underlying document, they could still change the viewport document with respect to what was anticipated in S430. As such, as shown in FIG. 4, if such event occurs (“yes” in S450), it may be necessary to repeat operations S430 and S440 based on the new event information.

Another example of how the buffer drawing operations of S440 may be interrupted is when an event occurs changing the document to be displayed, as illustrated in S460. Such events may occur based on a user command, e.g., clicking on a link in a webpage document, performing a “refresh” of the current webpage document, or opening a new document file. It is also possible for such events to occur without user interaction. Web browsers 200, for instance, are generally programmed to start rendering a webpage while the document data is still being loaded over the Internet. As such, the document data for one or more tiles may be incomplete by the time S440 starts rendering (e.g., the text of a particular tile may be available before the tile's images are). Thus, as additional data is loading, this may cause the document rendering (S440) to be interrupted (“yes” in S460) in order to retrieve such data (S410). As another example, a browser 200 may be configured to automatically reload the displayed document at regular intervals. When such reload event occurs (“yes” in S450), the process may need to return to S410 in order to receive the reloaded document data.

Upon completion of the asynchronous rendering process 400, it may be repeated as necessary, e.g., when a new document is to be displayed, the current document is being reloaded, or the user inputs a command to change the document view.

Reference will now be made to the screen refresh process 500 illustrated in FIG. 5. For each refresh cycle, the process 500 may start by receiving the document data as shown in operation S510. Using this data, operation S520 can divide the document into tiles and perform the appropriate processing to determine which of these document tiles are contained in the viewport for the current screen refresh. However, as discussed above, it is not strictly necessary for the screen refresh thread 40 to be responsible for dividing the document into tiles. Instead, the document can be divided elsewhere, and the document tiles can be defined within the received document data.

After the tiles of the viewport document are determined (S520), each of the corresponding tile buffers in the rendering cache 30 which have been rendered in time by the asynchronous rendering thread 10, are painted onto the screen according to operation S530. I.e., S530 paints those parts of the viewport document which have been asynchronously drawn in high detail. Thereafter, a determination is made in S540 as to whether any part of the viewport document has not been completed by the asynchronous rendering thread 10 in time for the current refresh, i.e., based on the statuses of the tile buffers. If any part of the viewport document has not been rendered asynchronously in time (“yes” in S540), the synchronous rendering function 20 is invoked in order to paint low-detail versions of the missing document tiles, as shown in S550. This process 500 may be repeated for each refresh cycle (as shown in S560) while the document is being displayed on the device.

While exemplary embodiments of the present invention have been described above, variations may be made thereto consistent with the spirit and scope of the present invention.

For instance, while embodiments are described above using two separate threads for high-detail and low-detail rendering, respectively, another option would be to employ a single synchronous thread which adaptively changes the level of detail of the document it draws during each refresh. This could be accomplished, e.g., by setting a limit in terms of CPU time (instruction cycles) or a “complexity” metric. The thread could determine which parts of the document are likely to fall within the viewport during the next few refreshes, judge the drawing complexity of those parts, and increase or decrease the level of detail based on the set limits.

It should also be understood that while the exemplary embodiments include certain combinations of features, some of which are not present in all embodiments, the invention is not limited to the combinations explicitly discussed in the foregoing. Consequently, features that are not explicitly described as depending on each other in order to operate, may or may not be present in a particular embodiment of the invention whether or not they have been described as such above. For the sake of brevity and clarity, all possible permutations of disclosed features have not been explicitly listed, but persons with skill in the art will understand that the omission of certain such combinations does not mean that they are not part of the invention as disclosed through the examples presented herein.

What is claimed is:

1. A method implemented by a computer application for rendering an electronic document comprising:
utilizing one or more processors to:
concurrently execute first and second threads, respectively, the first thread being programmed to render a low-detail version of the document as necessary synchronous with a screen refresh cycle by the application, the second thread being programmed to render a high-detail version of the document asynchronously with respect to the screen refreshes; and
during each refresh cycle,
paint onto a computer screen at least part of the document currently in a viewport of the application using the high-detail version rendered by the second thread, and
if a part of the document in the viewport is unfinished in the high-detail version, paint a low-detail version of the unfinished part as synchronously-rendered by the first thread.

2. The method according to claim 1, wherein the second thread renders the high-detail version of the document to a rendering cache, and the process paints contents of the rendering cache onto the computer screen during each refresh cycle.

3. The method according to claim 2, wherein
the document is partitioned into a plurality of tiles, and
the cache includes a plurality of buffers corresponding to the plurality of tiles, respectively, the second thread being programmed to draw different portions of the high-detail version of the document, respectively, to the plurality of buffers.

4. The method according to claim 1, wherein the first thread renders the low-detail version of the unfinished part of the document by omitting one or more types of document elements that are rendered in the high-detail version of the document by the second thread.

5. The method according to claim 4, wherein the one or more types of document elements omitted by the first thread include images, the first thread replacing images in the document with colored boxes when rendering the low-detail version of the document.

6. The method according to claim 4, wherein the one or more types of document elements omitted by the first thread include text.

7. The method according to claim 1, wherein the second thread renders the high-detail version of the document by omitting one or more types of document elements that are rendered by the first thread.

8. The method according to claim 1, wherein the first thread is executed by a first processor, and the second thread is executed by a second processor.

9. The method according to claim 1, wherein
the computer application is a web browser executed on a client device, and
the document is a markup language document distributed to the client device from a server.

10. An electronic device for rendering an electronic document, comprising:
one or more processors programmed to:
concurrently execute first and second threads, respectively, the first thread being programmed to render a low-detail version of the document as necessary synchronous with a screen refresh cycle by the application, the second thread being programmed to render a high-detail version of the document asynchronously with respect to the screen refreshes; and
during each refresh cycle,
paint onto a computer screen at least part of the document currently in a viewport of the application using the high-detail version rendered by the second thread, and
if a part of the document in the viewport is unfinished in the high-detail version, paint a low-detail version of the unfinished part as synchronously-rendered by the first thread.

11. The electronic device according to claim 10, further comprising:
a rendering cache,
wherein the second thread renders the high-detail version of the document to the rendering cache, and the process paints contents of the rendering cache onto the computer screen during each refresh cycle.

12. The electronic device according to claim 11, wherein
the document is partitioned into a plurality of tiles, and
the cache includes a plurality of buffers corresponding to the plurality of tiles, respectively, the second thread being programmed to draw different portions of the high-detail version of the document, respectively, to the plurality of buffers.

13. The electronic device according to claim 10, wherein the first thread renders the low-detail version of the unfinished part of the document by omitting one or more types of document elements that are rendered in the high-detail version of the document by the second thread.

14. The electronic device according to claim 13, wherein the one or more types of document elements omitted by the first thread include images, the first thread replacing images in the document with colored boxes when rendering the low-detail version of the document.

15. The electronic device according to claim 13, wherein the one or more types of document elements omitted by the first thread include text.

16. The electronic device according to claim 10, wherein the second thread renders the high-detail version of the document by omitting one or more types of document elements that are rendered by the first thread.

17. The electronic device according to claim 10, wherein
the one or more processors include a first processor and a second processor, and
the first thread is executed by the first processor, and the second thread is executed by the second processor.

18. The electronic device according to claim 10, wherein the document is a markup language document distributed from a server to a web browser executed on the electronic device.

19. A non-transitory computer readable medium on which is stored coded instructions, which are executable by one or more processors to perform a process for rendering an electronic document, said process comprising:
concurrently executing first and second threads, respectively, the first thread being programmed to render a low-detail version of the document as necessary synchronous with a screen refresh cycle by the application, the second thread being programmed to render a high-detail version of the document asynchronously with respect to the screen refreshes; and
during each refresh cycle,
paint onto a computer screen at least part of the document currently in a viewport of the application using the high-detail version rendered by the second thread, and
if a part of the document in the viewport is unfinished in the high-detail version, paint a low-detail version of the unfinished part as synchronously-rendered by the first thread.

20. The computer readable medium according to claim 19, wherein the second thread renders the high-detail version of the document to a rendering cache, and the process paints contents of the rendering cache onto the computer screen during each refresh cycle.

21. The computer readable medium according to claim 20, wherein
the document is partitioned into a plurality of tiles, and
the cache includes a plurality of buffers corresponding to the plurality of tiles, respectively, the second thread being programmed to draw different portions of the high-detail version of the document, respectively, to the plurality of buffers.

22. The computer readable medium according to claim 19, wherein the first thread renders the low-detail version of the unfinished part of the document by omitting one or more types of document elements that are rendered in the high-detail version of the document by the second thread.

23. The computer readable medium according to claim 22, wherein the one or more types of document elements omitted by the first thread include images, the first thread replacing images in the document with colored boxes when rendering the low-detail version of the document.

24. The computer readable medium according to claim 22, wherein the one or more types of document elements omitted by the first thread include text.

25. The computer readable medium according to claim 19, wherein the second thread renders the high-detail version of the document by omitting one or more types of document elements that are rendered by the first thread.

26. The computer readable medium according to claim 19, wherein the first thread is executed by a first processor, and the second thread is executed by a second processor.

27. The computer readable medium according to claim 19, wherein
the instructions are implemented in a web browser that is executed on a client device, and
the document is a markup language document distributed to the client device from a server.
